(19) United States
(12) Patent Application Publication
(10) Pub. No.: US 2022/0080892 A1
(43) Pub. Date: Mar. 17, 2022

(54) VEHICLE BODY MOUNTED SIDE VIEW MIRROR ASSEMBLIES WITH ACCESSORY MOUNTING PLATFORMS

(71) Applicant: FORD GLOBAL TECHNOLOGIES, LLC, Dearborn, MI (US)

(72) Inventors: Duncan WHIPPS, Grosse Pointe Farms, MI (US); Stephen John AGDORNY, Ypsilanti, MI (US); Jonathan SZCZUPAK, Bloomfield Hills, MI (US); Joseph F. DENATALE, JR., Royal Oak, MI (US); Mary Beth ANGOTTI, Canton, MI (US)

(21) Appl. No.: 17/021,293

(22) Filed: Sep. 15, 2020

(51) Int. Cl. B60R 1/12; B60R 1/06; B62D 65/16

(52) U.S. Cl. CPC B60R 1/1207; B60R 1/06; B60R 2001/1253; B60R 2001/1261; B62D 65/16

(57) ABSTRACT

This disclosure details vehicle body mounted side view mirror assemblies that include mounting platforms for mounting one or more accessory items to the vehicle. The mounting platforms may be established by a mirror neck cover of the side view mirror assembly, a leaf screen, or both. The mounting platforms may include one or more mounting openings and associated fasteners for securing the accessory items directly to the side view mirror assembly.

### TECHNICAL FIELD

This disclosure relates to side view mirrors for motor vehicles, and more particularly to vehicle static body structure mounted side view mirror assemblies that include integrated accessory mounting platforms.

### BACKGROUND

Vehicle side view mirrors are typically mounted to driver and passenger side doors. Vehicles designed for off-road use often provide for the removal of the driver and passenger side doors. Removal of the side doors typically results in also removing the side view mirrors.

### SUMMARY

A side view mirror assembly for a vehicle according to an exemplary aspect of the present disclosure includes, among other things, a mirror housing assembly, a base frame connected to the mirror housing assembly, and a mirror neck cover positioned over the base frame. The mirror neck cover establishes at least a portion of an accessory mounting platform of the side view mirror assembly.

In a further non-limiting embodiment of the foregoing side view mirror assembly, the base frame is configured to couple to a bracket that is secured to a vehicle static body structure.

In a further non-limiting embodiment of either of the foregoing side view mirror assemblies, the mirror neck cover is configured to interface with a leaf screen within a leaf screen area of the vehicle.

In a further non-limiting embodiment of any of the foregoing side view mirror assemblies, the mirror neck cover establishes a first portion of the accessory mounting platform, and the leaf screen establishes a second portion of the accessory mounting platform.

In a further non-limiting embodiment of any of the foregoing side view mirror assemblies, the mirror neck cover establishes an entire mounting surface of the accessory mounting platform.

In a further non-limiting embodiment of any of the foregoing side view mirror assemblies, the accessory mounting platform includes a first mounting opening and a first fastener removably received within the first mounting opening.

In a further non-limiting embodiment of any of the foregoing side view mirror assemblies, the accessory mounting platform includes a second mounting opening and a second fastener removably received within the second mounting opening.

In a further non-limiting embodiment of any of the foregoing side view mirror assemblies, the first fastener is received by a boss of the base frame when positioned within the first mounting opening.

In a further non-limiting embodiment of any of the foregoing side view mirror assemblies, a shallow groove is formed in an exterior surface of the mirror neck cover.

In a further non-limiting embodiment of any of the foregoing side view mirror assemblies, the shallow groove delineates at least portion of an outer perimeter of the accessory mounting platform.

In a further non-limiting embodiment of any of the foregoing side view mirror assemblies, a camera, a light, or an antenna is mounted to the accessory mounting platform.

A vehicle according to another exemplary aspect of the present disclosure includes, among other things, a vehicle static body structure and a side view mirror assembly mounted to the vehicle static body structure. The side view mirror assembly includes a mirror neck cover that establishes at least a portion of an accessory mounting platform of the side view mirror assembly.

In a further non-limiting embodiment of the foregoing vehicle, the vehicle static body structure includes an A-pillar, a hinge pillar, a fender support, and a cowl structure.

In a further non-limiting embodiment of either of the foregoing vehicles, the side view mirror assembly is mounted at joint interface between the A-pillar, the hinge pillar, the fender support, and the cowl structure.

In a further non-limiting embodiment of any of the foregoing vehicles, the mirror neck cover is configured to interface with a leaf screen within a leaf screen area of the vehicle static body structure. The mirror neck cover establishes a first portion of the accessory mounting platform, and the leaf screen establishes a second portion of the accessory mounting platform.

In a further non-limiting embodiment of any of the foregoing vehicles, the accessory mounting platform includes a first mounting opening and a first fastener removably received within the first mounting opening.

In a further non-limiting embodiment of any of the foregoing vehicles, a camera, a light, or an antenna is mounted to the accessory mounting platform via the first fastener.

In a further non-limiting embodiment of any of the foregoing vehicles, a shallow groove is formed in an exterior surface of the mirror neck cover and is configured to delineate an outer perimeter of the accessory mounting platform.

In a further non-limiting embodiment of any of the foregoing vehicles, a removable door is mounted to the vehicle static body structure.

A method according to another exemplary aspect of the present disclosure includes, among other things, removing a first fastener from a mounting platform of a vehicle side view mirror assembly, positioning an accessory item against the mounting platform, and securing the accessory item to the mounting platform with the first fastener or a second fastener.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 is a front view of a motor vehicle equipped with side view mirror assemblies.

FIG. 2 is a perspective view of select portions of the vehicle of FIG. 1.

FIG. 3 illustrates a vehicle static body structure mounting location of an exemplary side view mirror assembly.

FIG. 4 is a top view of the exemplary side view mirror assembly.

FIG. 5 is a partially cut-away view of the exemplary side view mirror assembly.

FIG. 6 illustrates an exemplary mounting platform of a side view mirror assembly.

FIG. 7 illustrates another exemplary mounting platform of a side view mirror assembly.

FIG. 8 schematically illustrates an accessory item mounted to a mounting platform established by a vehicle body mounted side view mirror assembly.

FIG. 9 schematically illustrates another accessory item mounted to a mounting platform established by a vehicle body mounted side view mirror assembly.

FIG. 10 schematically illustrates yet another accessory item mounted to a mounting platform established by a vehicle body mounted side view mirror assembly.

### DETAILED DESCRIPTION

This disclosure details vehicle body mounted side view mirror assemblies that include mounting platforms for mounting one or more accessory items to the vehicle. The mounting platforms may be established by a mirror neck cover of the side view mirror assembly, a leaf screen, or both. The mounting platforms may include one or more mounting openings and associated fasteners for securing the accessory items directly to the side view mirror assembly. These and other features of this disclosure are described in greater detail below.

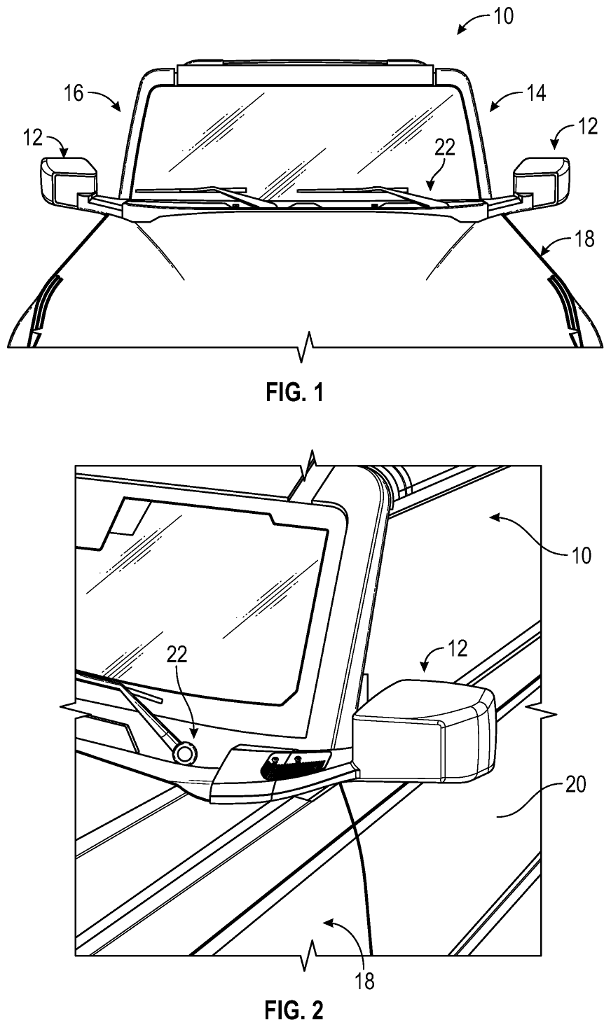

FIGS. 1-2 illustrate select portions of a motor vehicle 10. In an embodiment, the vehicle 10 is a sport utility vehicle (SUV). However, the teachings of this disclosure may also be applicable to cars, trucks, vans, or any other type of motor vehicles. The vehicle 10 could also be a conventional motor vehicle, a traction battery powered hybrid or electric vehicle, or an autonomous vehicle (i.e., a driverless vehicle).

Although a specific component relationship is illustrated in the figures of this disclosure, the illustrations are not intended to limit this disclosure. In other words, the placement and orientation of the various components of the vehicle 10 are shown schematically and could vary within the scope of this disclosure. In addition, the various figures accompanying this disclosure are not necessarily drawn to scale, and some features may be either exaggerated or minimized to show certain details of a particular component.

The vehicle 10 may include a side view mirror assembly 12 located on both a driver side 14 and a passenger side 16 of the vehicle 10. Each side view mirror assembly 12 is mounted to a vehicle static body structure 18 instead of a side door 20 of the vehicle 10. The side doors 20 of the vehicle 10 may be removed from the vehicle static body structure 18 to provide an open-air driving and riding experience. Door mounted side view mirrors are of course removed with the side doors 20. The exemplary side view mirror assemblies 12 of this disclosure may be mounted to structural vehicle body components within a leaf screen area 22 of the vehicle 10. Accordingly, each side view mirror assembly 12 remains mounted to the vehicle 10 even when the side doors 20 of the vehicle 10 are removed.

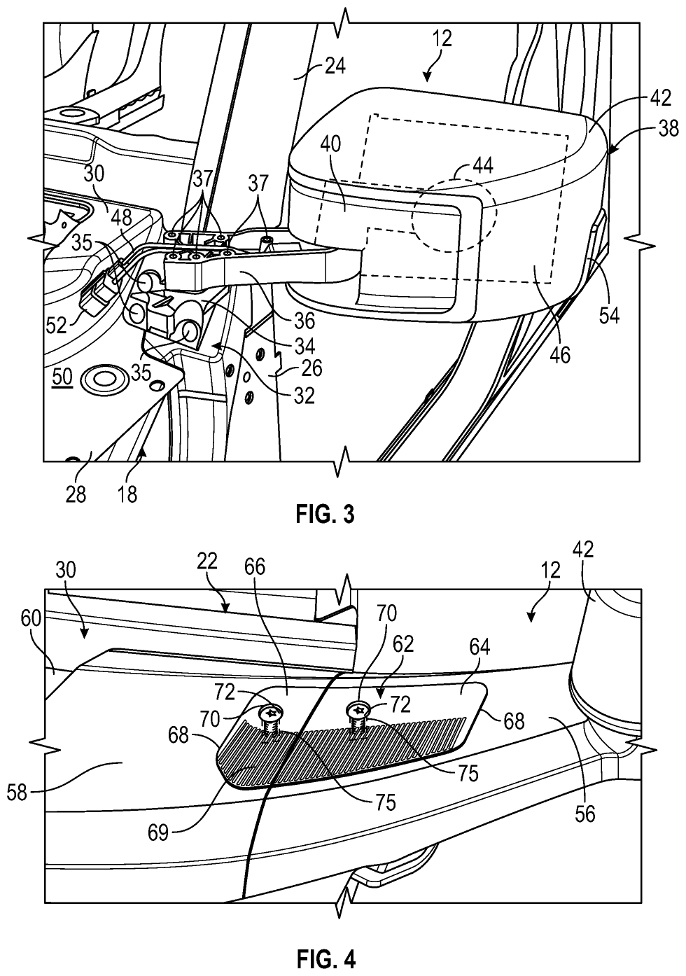

Referring to FIG. 3, with continued reference to FIGS. 1 and 2, the vehicle static body structure 18 may include portions of an A-pillar 24, a hinge pillar 26, a fender support 28, and a cowl structure 30. In an embodiment, the side view mirror assembly 12 is attached to the vehicle static body structure 18 at a joint interface 32 between the A-pillar 24, the hinge pillar 26, the fender support 28, and the cowl structure 30. However, the side view mirror assembly 12 could be attached at other locations of the vehicle static body structure 18, such as entirely on the A-pillar 24, the hinge pillar 26, the fender support 28, or the cowl structure 30. Although parts of the vehicle static body structure 18 are disclosed by way of example, the side view mirror assembly 12 of FIG. 3 could be attached to any portion of the vehicle static body structure 18.

A bracket 34 of the side view mirror assembly 12 may be mounted to the vehicle static body structure 18, such as at the joint interface 32. One or more fasteners 35, such as screws or bolts, may be used to secure the bracket 34 at the joint interface 32.

The bracket 34 is configured to support a base frame 36 and a mirror housing assembly 38 of the side view mirror assembly 12. The base frame 36 may be secured to the bracket 34 via one or more additional fasteners 37. The base frame 36, and thereby the mirror housing assembly 38 of the side view mirror assembly 12, may be removed from the bracket 34 for service or maintenance if needed.

The mirror housing assembly 38 may include an arm 40 that extends inside an outer mirror housing 42. The arm 40 may support a motor 44 and a mirror 46 relative to the outer mirror housing 42. The arm 40 may be pivotably connected to the base frame 36 for adjusting a position of the mirror housing assembly 38.

An electric conduit 48 may be routed through the base frame 36 and into a dry area 50 of the vehicle 10. A connector 52 of the electric conduit 48 may be attached to applicable power and control conduits (not shown) to power and control the motor 44 for adjusting a position of the mirror 46 relative to the outer mirror housing 42.

The side view mirror assembly 12 may additionally include an electrical feature such as, for example, a light 54. In an embodiment, the light 54 is a turn signal lamp. The light 54 is shown by way of example, and other lighting features could also be included in the side view mirror assembly 12, such as a spot light or blind spot information system light, for example. The side view mirror assembly 12 may include other electrical features such as, for example, a mirror defroster, puddle lamp, turn signal and/or any other electrical feature complementing operation of the vehicle 10 and the side view mirror assembly 12. The side view mirror assembly 12 could alternatively include no lights within the scope of this disclosure.

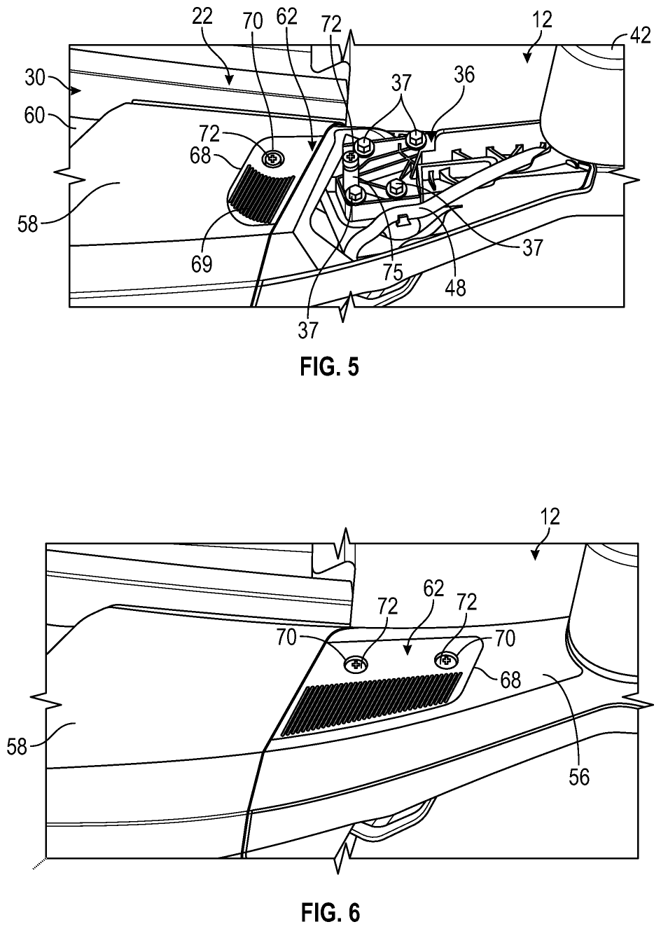

FIGS. 4 and 5, with continued reference to FIGS. 1-3, illustrate additional features associated with the side view mirror assembly 12. The side view mirror assembly 12 may include a mirror neck cover 56 that is positionable over the base frame 36. The mirror neck cover 56 may therefore conceal the base frame 36 and portions of the electrical conduit 48. The mirror neck cover 56 is shown attached in FIG. 4 and removed from the side view mirror assembly 12 in FIG. 5.

The mirror neck cover 56 may interface with a leaf screen 58 within the leaf screen area 22. The leaf screen 58 may be secured at an upper surface 60 of the cowl structure 30. The mirror neck cover 56 may flow seamlessly into the leaf screen 58 such that these components appear as an integrated unit. Accordingly, in some embodiments, the leaf screen 58 may be considered as being part of the side view mirror assembly 12.

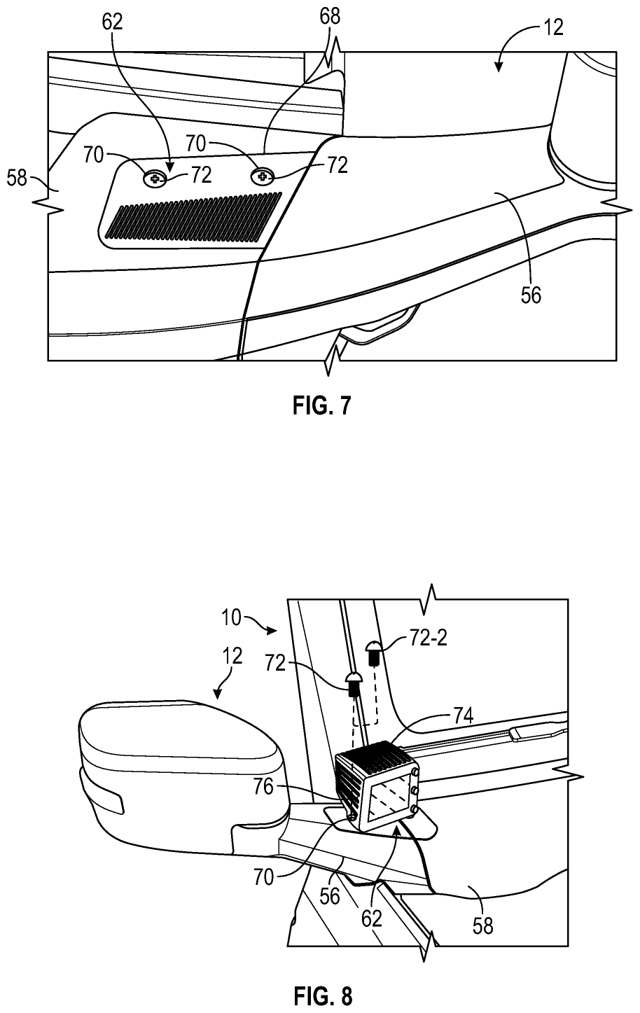

The side view mirror assembly 12 may include a mounting platform 62 configured for securing one or more accessory items (e.g., additional lights, cameras, antennas, etc.) to the vehicle 10. In an embodiment, a first portion 64 of the mounting platform 62 is established by the mirror neck cover 56 and a second portion 66 of the mounting platform 62 is established by the leaf screen 58 (see FIG. 4). In another embodiment, an entirety of the mounting platform 62 is established by the mirror neck cover 56 (see FIG. 6). Therefore, in this embodiment, an entire outer perimeter of the mounting platform 62 may be formed on the exterior surface of the mirror neck cover 56. In yet another embodiment, an entirety of the mounting platform 62 is established by the leaf screen 58 (see FIG. 7). Therefore, in this embodiment, an entire outer perimeter of the mounting platform 62 may be formed on the exterior surface of the lead screen 58.

A shallow groove 68 may delineate the outer perimeter of the mounting platform 62. The shallow groove 68 may be formed in the exterior surface of the mirror neck cover 56, the leaf screen 58, or both. The mounting platform 62 may therefore provide a clearly delineated mounting location for supporting various accessory items. The overall size and shape of the mounting platform is not intended to limit this disclosure.

One or more mounting openings 70 may be formed in the mounting platform 62. Each mounting opening 70 may receive a fastener 72 (e.g., a bolt, screw, etc.). In an embodiment, the fastener 72 is a threaded fastener. When received within the mounting openings 70, the fasteners 72 may be accommodated within bosses 75 of the base frame 36, the cowl structure 30, or both. In an embodiment, the bosses 75 are internally threaded for receiving threads of the fastener 72.

The fasteners 72 may be selectively removed from the mounting openings 70 and then reused to secure accessory items to the mounting platform 62, as is further discussed below. Although two mounting openings 70 and two fasteners 72 are illustrated in the figures, the mounting platform 62 could be provided with a greater or fewer number of mounting openings and fasteners within the scope of this disclosure.

A ribbed surface 69 may be provided on the mounting platform 62. The ribbed surface 69 provides an aesthetically pleasing styling element to the side view mirror assembly 12.

As iterated above, the mounting platform 62 of the side view mirror assembly 12 may provide a mounting location for supporting one or more accessory items on the vehicle 10. In the exemplary embodiment of FIG. 8, for example, the accessory item is a camera 74 that is attached to the mounting platform 62 by way of one or more of the mounting openings 70/fasteners 72.

The camera 74 may be mounted to the mounting platform 62 in the following exemplary manner. At least one the fasteners 72 may first be removed from its corresponding mounting opening 70, the camera 74 may next be positioned against the mounting platform 62, and the fastener 72 that was previously removed may then be inserted through a mounting portion 76 of the camera 74 and back into the mounting opening 70. Alternatively, a different fastener 72-2 than the fastener 72 removed from the mounting opening 70 may be inserted through the mounting portion 76 and into the mounting opening 70 for securing the camera 74 to the mounting platform 62.

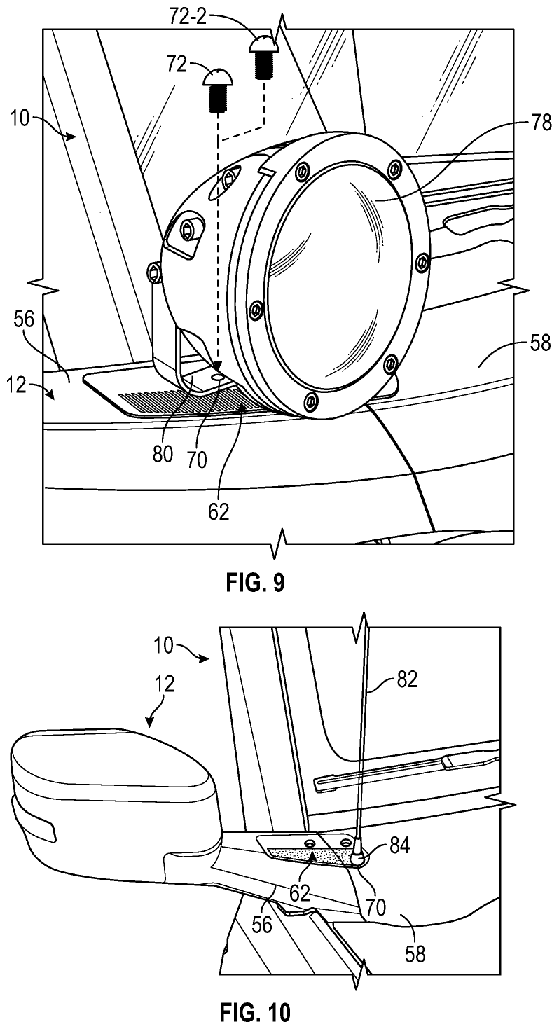

In the exemplary embodiment of FIG. 9, the accessory item is a light 78 that is attached to the mounting platform 62 by way of one or more of the mounting openings 70/fasteners 72. The light 78 may be mounted to the mounting platform 62 in the following exemplary manner. At least one the fasteners 72 may first be removed from its corresponding mounting opening 70, the light 78 may next be positioned against the mounting platform 62, and the fastener 72 that was previously removed may then be inserted through a mounting portion 80 of the light 78 and back into the mounting opening 70. Alternatively, a different fastener 72-2 than the fastener 72 removed from the mounting opening 70 may be inserted through the mounting portion 80 and into the mounting opening 70 for securing the light 78 to the mounting platform 62

In the exemplary embodiment of FIG. 10, the accessory item is an antenna 82. The antenna 82 may be secured within one of the mounting openings 70 of the mounting platform 62. The antenna 82 may be secured to the mounting platform 62 in the following exemplary manner. At least one the fasteners 72 may first be removed from its corresponding mounting opening 70. Next, a threaded portion 84 of the antenna 82 may be screwed into the mounting opening 70 for securing the antenna 82 to the mounting platform 62.

Cameras, lights, and antennas are but non-limiting examples of the types of accessory items that could be mounted to the mounting platform 62 of the side view mirror assembly 12. Therefore, as would be readily understood by persons of ordinary skill in the art, any desired type of accessory item could be mounted to the vehicle 10 via the mounting platform 62.

The vehicle body mounted side view mirror assemblies of this disclosure include integrated through-mirror accessory mounting platforms for securing accessory items to a vehicle. The exemplary mirror assemblies therefore provide for a “doors-off” open air riding experience in which the mirrors are still available for use on the vehicle while also leveraging the space afforded by the body mounted mirror assemblies for mounting a multitude of accessory add-on items.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A side view mirror assembly for a vehicle, comprising:
a mirror housing assembly;
a base frame connected to the mirror housing assembly; and
a mirror neck cover positioned over the base frame,
wherein the mirror neck cover establishes at least a portion of an accessory mounting platform of the side view mirror assembly.

2. The side view mirror assembly as recited in claim 1, wherein the base frame is configured to couple to a bracket that is secured to a vehicle static body structure.

3. The side view mirror assembly as recited in claim 1, wherein the mirror neck cover is configured to interface with a leaf screen within a leaf screen area of the vehicle.

4. The side view mirror assembly as recited in claim 3, wherein the mirror neck cover establishes a first portion of the accessory mounting platform and the leaf screen establishes a second portion of the accessory mounting platform.

5. The side view mirror assembly as recited in claim 1, wherein the mirror neck cover establishes an entire mounting surface of the accessory mounting platform.

6. The side view mirror assembly as recited in claim 1, wherein the accessory mounting platform includes a first mounting opening and a first fastener removably received within the first mounting opening.

7. The side view mirror assembly as recited in claim 6, wherein the accessory mounting platform includes a second mounting opening and a second fastener removably received within the second mounting opening.

8. The side view mirror assembly as recited in claim 6, wherein the first fastener is received by a boss of the base frame when positioned within the first mounting opening.

9. The side view mirror assembly as recited in claim 1, wherein a shallow groove is formed in an exterior surface of the mirror neck cover.

10. The side view mirror assembly as recited in claim 9, wherein the shallow groove delineates at least portion of an outer perimeter of the accessory mounting platform.

11. The side view mirror assembly as recited in claim 1, comprising a camera, a light, or an antenna mounted to the accessory mounting platform.

12. A vehicle, comprising:
a vehicle static body structure; and
a side view mirror assembly mounted to the vehicle static body structure and including a mirror neck cover that establishes at least a portion of an accessory mounting platform of the side view mirror assembly.

13. The vehicle as recited in claim 12, wherein the vehicle static body structure includes an A-pillar, a hinge pillar, a fender support, and a cowl structure.

14. The vehicle as recited in claim 13, wherein the side view mirror assembly is mounted at joint interface between the A-pillar, the hinge pillar, the fender support, and the cowl structure.

15. The vehicle as recited in claim 12, wherein the mirror neck cover is configured to interface with a leaf screen within a leaf screen area of the vehicle static body structure, and further wherein the mirror neck cover establishes a first portion of the accessory mounting platform and the leaf screen establishes a second portion of the accessory mounting platform.

16. The vehicle as recited in claim 12, wherein the accessory mounting platform includes a first mounting opening and a first fastener removably received within the first mounting opening.

17. The vehicle as recited in claim 16, comprising a camera, a light, or an antenna mounted to the accessory mounting platform via the first fastener.

18. The vehicle as recited in claim 12, wherein a shallow groove is formed in an exterior surface of the mirror neck cover and is configured to delineate an outer perimeter of the accessory mounting platform.

19. The vehicle as recited in claim 12, comprising a removable door mounted to the vehicle static body structure.

20. A method, comprising:
removing a first fastener from a mounting platform of a vehicle side view mirror assembly;
positioning an accessory item against the mounting platform; and
securing the accessory item to the mounting platform with the first fastener or a second fastener.
